(19) United States
(12) Patent Application Publication
(10) Pub. No.: US 2024/0355093 A1
(43) Pub. Date: Oct. 24, 2024

(54) DETERMINATION DEVICE, INSPECTION SYSTEM, DETERMINATION METHOD, AND STORAGE MEDIUM

(71) Applicant: KABUSHIKI KAISHA TOSHIBA, Tokyo (JP)

(72) Inventors: Miyuki UCHIDA, Yokohama Kanagawa (JP); Taisuke WASHITANI, Yokohama Kanagawa (JP)

(21) Appl. No.: 18/762,464

(22) Filed: Jul. 2, 2024

Related U.S. Application Data
(63) Continuation of application No. PCT/JP2022/045055, filed on Dec. 7, 2022.

(30) Foreign Application Priority Data
Jan. 4, 2022 (JP) 2022000059

(51) Int. Cl. G06V 10/764; G06T 7/00; G06V 10/82

(52) U.S. Cl. CPC G06V 10/764; G06T 7/0008; G06V 10/82; G06T 2207/30164

(57) ABSTRACT

According to one embodiment, a determination device is configured to determine a suitability of a classification model. The classification model includes a neural network. The classification model is further configured to output a classification result according to an input of an image. The determination device is further configured to acquire intermediate data of an intermediate layer of the neural network when an input image is input to the classification model. The classification model is further configured to determine the suitability by using a plurality of sets of the intermediate data and a plurality of sets of reference data. The plurality of sets of reference data being prepared beforehand.

### CROSS-REFERENCE TO RELATED APPLICATIONS

This is a continuation application of International Patent Application PCT/JP2022/045055, filed on Dec. 7, 2022. This application also claims priority to Japanese Patent Application No. 2022-000059, filed on Jan. 4, 2022. The entire contents of which are incorporated herein by reference.

### FIELD

Embodiments described herein relate generally to a determination device, an inspection system, a determination method, and storage medium.

### BACKGROUND

There are cases where a classification model is used to automatically classify images. For example, the classification model includes a neural network. The accuracy of the classification by the classification model may change according to the images that are input.

### BRIEF DESCRIPTION OF THE DRAWINGS

FIG. 1 is a schematic view showing a configuration of an inspection system according to an embodiment;

FIG. 2 is a schematic view showing the configuration of the classification model;

FIG. 3 is a flowchart showing a determination method according to an embodiment;

FIG. 4 is a flowchart showing a determination method of the suitability;

FIG. 5 is a schematic view for describing the determination method of the suitability;

FIG. 6 is a flowchart showing a determination method of the suitability in a first modification;

FIG. 7 is a schematic view for describing the determination method of the suitability according to the first modification;

FIG. 8 is a flowchart showing a determination method of the suitability in a second modification;

FIG. 9 is a schematic view for describing another determination method according to the first modification;

FIG. 10 is a schematic view showing another configuration of the classification model;

FIGS. 11A and 11B are schematic views showing effects of metric learning;

FIG. 12 is a schematic view showing a configuration of another inspection system according to an embodiment;

FIG. 13 is a flowchart showing an example of the determination method according to the embodiment; and

FIG. 14 is a schematic view showing a hardware configuration.

### BRIEF DESCRIPTION OF THE DRAWINGS

According to one embodiment, a determination device is configured to determine a suitability of a classification model.

The classification model includes a neural network. The classification model is further configured to output a classification result according to an input of an image. The determination device is further configured to acquire intermediate data of an intermediate layer of the neural network when an input image is input to the classification model. The classification model is further configured to determine the suitability by using a plurality of sets of the intermediate data and a plurality of sets of reference data. The plurality of sets of reference data being prepared beforehand.

Various embodiments will be described hereinafter with reference to the accompanying drawings. In the specification and drawings, components similar to those described or illustrated in a drawing thereinabove are marked with like reference numerals, and a detailed description is omitted as appropriate.

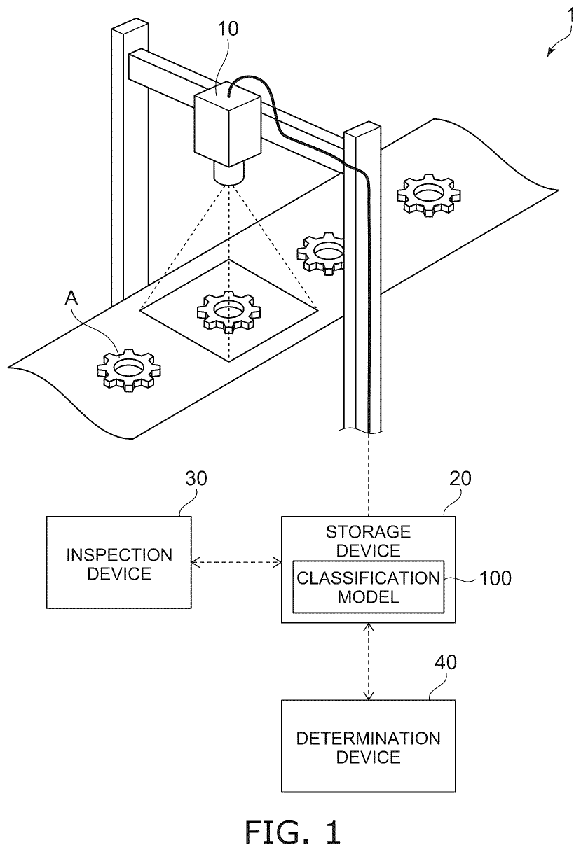

FIG. 1 is a schematic view showing a configuration of an inspection system according to an embodiment.

As shown in FIG. 1, the inspection system 1 according to the embodiment includes an imaging device 10, a storage device 20, an inspection device 30, and a determination device 40.

The imaging device 10 acquires an image by imaging an article A to be inspected. The imaging device 10 may acquire a video image. In such a case, a still image is cut out from the video image. The imaging device 10 stores the image in the storage device 20.

The storage device 20 stores a classification model 100 that outputs the result of a classification (into classes) according to the input of images. The classification model 100 includes a neural network. The classification model 100 is pretrained before being used in the inspection. The storage device 20 is connected with the imaging device 10, the inspection device 30, and the determination device 40 via a network, wired communication, or wireless communication.

The inspection device 30 accesses the storage device 20 and acquires the classification model 100 and an input image to be input to the classification model 100. The inspection device 30 may directly receive the input image from the imaging device 10. The inspection device 30 inspects the article visible in the input image by using the classification model 100 and the input image.

In the inspection, the inspection device 30 inputs the input image to the classification model 100. The inspection device 30 acquires the classification result of the input image from the classification model 100. The classification result corresponds to the inspection result of the article visible in the input image. The inspection device 30 outputs the inspection result of the article according to the classification result.

By using the image and the classification model 100, the appearance of the article can be inspected with high accuracy without using an expensive inspection device. On the other hand, when the quality of the input image changes, the accuracy of the classification by the classification model 100 also may change.

For example, the quality of the input image changes due to a change of the brightness of the space in which the article A and the imaging device 10 are located, the relative positional relationship between the article A and the imaging device 10, the appearance of the article A, etc. The inspection accuracy may be reduced by the change of the quality of the input image. In other words, there is a possibility that the suitability of the classification model 100 to the inspection may degrade.

The determination device 40 determines the suitability of the classification model 100 to the inspection. For example, the determination device 40 determines when the suitability of the classification model 100 may be about to degrade due to a change of the quality of the input image, even though there is no error in the inspection result.

A configuration of the classification model 100 and a determination method of the determination device 40 will now be described.

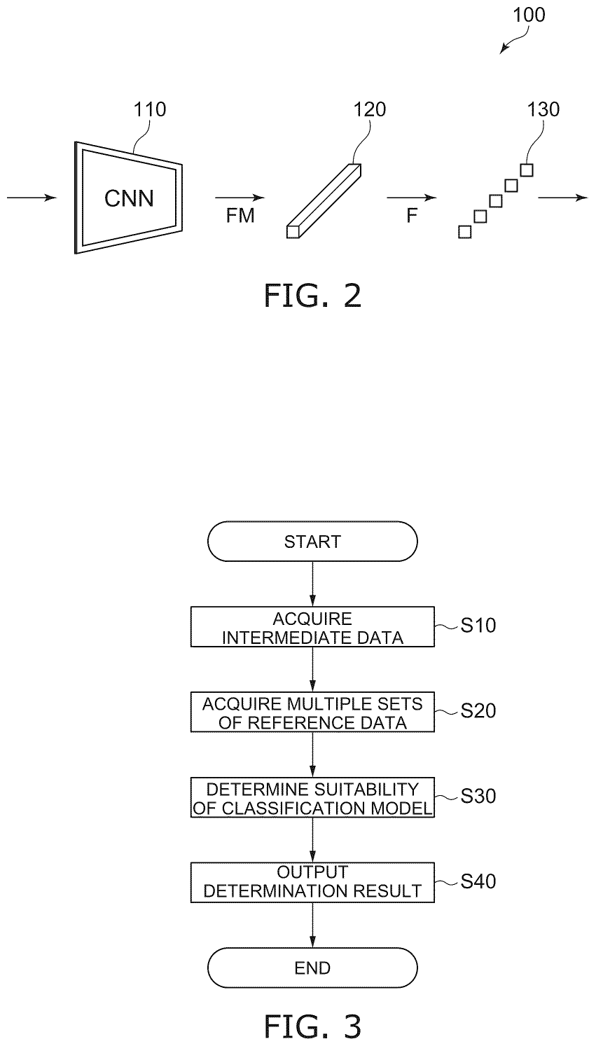

FIG. 2 is a schematic view showing the configuration of the classification model.

The classification model 100 includes a neural network. As shown in FIG. 2, the neural network includes, for example, a convolutional neural network (CNN) 110, a fully connected layer 120, and a fully connected layer 130.

An image is input to the CNN 110. The CNN 110 includes convolutional layers, pooling layers, etc. The CNN 110 outputs a feature map FM according to the input image. The fully connected layer 120 is located after the CNN 110. The fully connected layer 120 connects the data of the feature map FM to the nodes of the fully connected layer 130. Multiple features F are output from the fully connected layer 120. The fully connected layer 130 outputs a result representing the class of the input image.

The training method of the classification model 100 is arbitrary as long as the classification model 100 can classify the image. For example, metric learning can be used to control the feature space.

FIG. 3 is a flowchart showing a determination method according to an embodiment.

When the input image is input to the classification model 100, not only the classification result, but also data of an intermediate layer (intermediate data) of the neural network included in the classification model 100, is acquired. For example, the output from the fully connected layer 120 is acquired as the intermediate data.

The determination device 40 acquires the intermediate data from the classification model 100 (step S10). The determination device 40 acquires the intermediate data each time an image is input to the classification model. Multiple sets of intermediate data are acquired thereby. The inspection device 30 may acquire the intermediate data and store the intermediate data in the storage device 20. In such a case, the determination device 40 acquires the intermediate data from the storage device 20.

The determination device 40 acquires multiple sets of reference data that are prepared beforehand (step S20).

Similarly to the intermediate data, the reference data is acquired from an intermediate layer when an image is input to the classification model 100. For example, multiple reference images are sequentially input to the classification model 100 directly after the training of the classification model is completed. The reference data is acquired respectively when the reference images are input. Images that were used in the training may be used as the reference data. It is favorable for the images used as the reference data to have properties equivalent to those of the data when training, and to be data directly before the completion of the training.

The determination device 40 determines the suitability of the classification model 100 by using the multiple sets of intermediate data acquired in step S10 and the multiple sets of reference data acquired in step S20 (step S30). The determination device 40 outputs the determination result of the suitability of the classification model 100 (step S40).

Advantages of the embodiment will now be described.

As described above, there is a possibility that the accuracy of the classification by the classification model may decrease when the quality of the input image changes. It is therefore favorable to update the classification model as appropriate. For example, a method may be considered in which the classification model is updated regularly regardless of the change of the classification model accuracy. However, in such a method, there is a possibility that the classification model may be updated uselessly, and the load necessary to update and manage the classification model is large. On the other hand, if the classification model is not updated until after the accuracy has decreased, improper inspections are performed until the decrease of the accuracy is discovered. For example, there is a possibility that many defective parts may be passed on, resulting in damages. Also, inspections cannot be performed from when the decrease of the accuracy is discovered until the classification model is updated.

When the quality of the input image changes and a decrease of the classification model accuracy occurs, the trend of the data output from the intermediate layer of the classification model changes. The change of the trend may occur regardless of the classification result of the classification model, and so the decrease of the classification model accuracy is easily discovered before becoming pronounced. By using the data output from the intermediate layer, the degradation of the suitability of the classification model to the inspection can be determined at an earlier timing. Even when the accuracy of the classification model decreases, the degradation of the suitability can be discovered more promptly than when the suitability of the classification model is determined based on the classification result. For example, by referring to the determination result of the determination device 40, it is easy for the user to determine whether or not it is appropriate to continue the use of the classification model 100.

The determination device 40 according to the embodiment acquires the intermediate data of the intermediate layer of the neural network included in the classification model. Then, the determination device 40 determines the suitability by using multiple sets of intermediate data and multiple sets of reference data prepared beforehand. According to this method, the suitability of the classification model to the inspection can be determined before the accuracy of the classification model decreases. By updating the classification model as appropriate based on the determination result, it is unnecessary to uselessly update the classification model. The classification model can be updated before the accuracy decreases.

Specific processing by the determination device 40 will now be described.

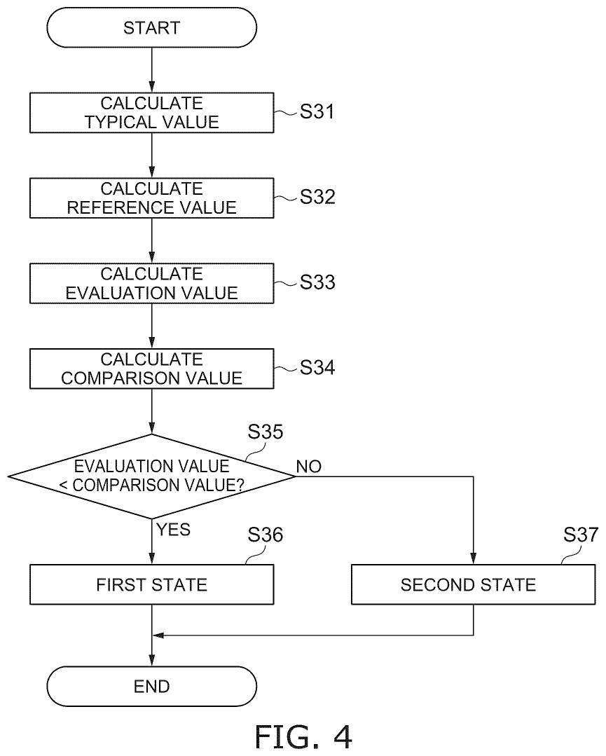

FIG. 4 is a flowchart showing a determination method of the suitability.

In step S30, for example, as shown in FIG. 4, the determination device 40 calculates a typical value by using multiple sets of intermediate data (step S31). The typical value is a median value or an average value of the multiple sets of intermediate data. The typical value may be a weighted average value or the like of the multiple sets of intermediate data. The intermediate data that is used to calculate the typical value is extracted from all of the intermediate data. For example, multiple sets of intermediate data obtained during a prescribed period referenced to the time at which the newest intermediate data was obtained are extracted. A prescribed number of sets of the intermediate data in order from newest may be extracted. The prescribed period or prescribed number is set according to the change of the intermediate data, the change of the accuracy of the classification model 100, etc., when the quality of the input image changes. When too much intermediate data is used to calculate the typical value, the change of the quality of the input image is not easily reflected in the typical value. On the other hand, when too few sets of intermediate data are used to calculate the typical value, there is a possibility that the suitability of the classification model 100 may be misjudged due to effects of the error, outliers, etc.

The determination device 40 calculates a reference value by using multiple sets of reference data (step S32). The reference value is a median value or an average value of the multiple sets of reference data. The reference value may be a weighted average value or the like of the multiple sets of reference data. The reference value is calculated by the same calculation method as that of the typical value. For example, when the typical value is the median value of the multiple sets of intermediate data, the reference value is the median value of the multiple sets of reference data.

The determination device 40 uses the typical value and the reference value to calculate an evaluation value representing the similarity between the multiple sets of intermediate data and the multiple sets of reference data (step S33). For example, the evaluation value is a distance between the typical value and the reference value. The Euclidean distance, the Mahalanobis distance, or the like can be used as the distance. The evaluation value may be an angle between the typical value and the reference value. Cosine similarity can be used as the angle. The determination device 40 uses multiple sets of reference data to calculate a comparison value to be compared with the evaluation value (step S34). The comparison value is set based on a distribution of the multiple sets of reference data. When the distance is used as the evaluation value, the comparison value can be set based on the standard deviation, mean squared error, variance, or quartiles (1Q and 3Q) of the distances between the reference value and the multiple sets of reference data. When the angle is used as the evaluation value, the comparison value can be set based on the standard deviation, mean squared error, variance, or quartiles (1Q and 3Q) of the angles between the reference value, the origin, and the multiple sets of reference data. As an example, the evaluation value is set to 3 times the standard deviation.

The determination device 40 compares the evaluation value with the comparison value (step S35). For example, when the distance is used as the evaluation value, a small evaluation value indicates a small change of the trend of the data of the intermediate layer. In such a case, the determination device 40 determines whether or not the evaluation value is less than the comparison value. The case where the distance is used as the evaluation value will now be described.

When the evaluation value is less than the comparison value, the determination device 40 determines that the suitability of the classification model 100 is in a first state (step S36). For example, the determination result indicates that the quality of the input image has not changed greatly from the reference image, and the classification model 100 is still favorable for the inspection.

When the evaluation value is not less than the comparison value, the determination device 40 determines that the suitability of the classification model 100 is in a second state (step S37). Compared to the first state, the second state indicates that the suitability of the classification model 100 has degraded. For example, the determination result indicates that the quality of the input image has changed from the reference image, and there is a high likelihood of the accuracy of the classification model 100 decreasing in the near future.

When the cosine similarity is used as the evaluation value of the angle, within the range of −1 to 1, an evaluation value near 1 indicates that the change of the trend of the data of the intermediate layer is small. In such a case, the determination device 40 determines whether or not the evaluation value is greater than a comparison value set within the range of −1 to 1. When the evaluation value is greater than the comparison value, the determination device 40 determines that the suitability of the classification model 100 is in the first state. When the evaluation value is not more than the comparison value, the determination device 40 determines that the suitability of the classification model 100 is in the second state.

Although an example in which the distance is used as the evaluation value is mainly described thereafter, the angle (the cosine similarity) also can be utilized as the evaluation value as described above. When the cosine similarity is used as the evaluation value of the angle, the comparison value is set within the range of −1 to 1 to correspond to the cosine similarity; and the suitability of the classification model 100 is similarly determined based on the magnitude relationship between the comparison value and the evaluation value.

When the suitability of the classification model 100 is determined, the determination device 40 outputs the determination result. For example, the determination device 40 transmits a notification indicating the determination result to a specific terminal device. The determination device 40 may store the determination result in the storage device 20. The determination device 40 may transmit a notification only when a specific determination result is obtained. For example, the determination device 40 transmits a notification only when the suitability of the classification model 100 is determined to be in the second state.

In the example above, the determination device 40 determines whether the suitability of the classification model 100 is in one of two states. The determination device 40 is not limited to the example; the determination device 40 may determine whether the suitability of the classification model 100 is in three or more states. In such a case, multiple comparison values are set. The state of the suitability of the classification model 100 is determined according to the comparison result between the evaluation value and the multiple comparison values.

According to the method described above, the execution sequence of steps S31 to S34 is modifiable as appropriate. Steps S32 and S34 are omissible when the reference value and the comparison value have already been calculated when determining a previous suitability and the values are referenceable.

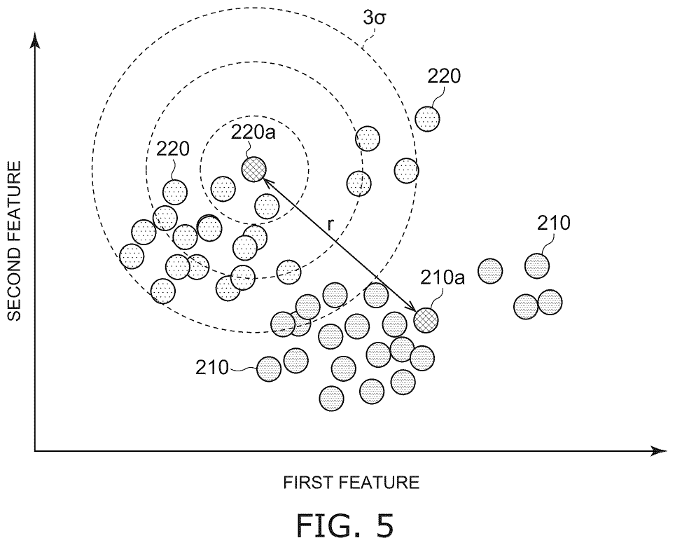

FIG. 5 is a schematic view for describing the determination method of the suitability.

FIG. 5 shows multiple sets of intermediate data 210 and multiple sets of reference data 220 in a feature space of a first feature and a second feature.

For example, as shown in FIG. 5, the determination device 40 calculates a typical value 210a of the multiple sets of intermediate data 210 and a reference value 220a of the multiple sets of reference data 220. The determination device 40 calculates a distance r between the typical value 210a and the reference value 220a. The determination device 40 also calculates 3 times the standard deviation σ of the multiple sets of reference data 220 as the comparison value. The distance r is greater than the comparison value 3σ. Therefore, the suitability of the classification model 100 is determined to be in the second state.

### First Modification

Instead of the determination method described above, the determination device 40 may calculate the typical value, the reference value, etc., according to the class (the classification result) of the image. As an example, the classification model 100 classifies the input images into one of a first class or a second class. The first class indicates that the article visible in the image is a good part. The second class indicates that the article visible in the image is a defective part.

The multiple images that are the basis of the multiple sets of intermediate data include multiple first input images and multiple second input images. The first input image is classified into the first class when input to the classification model 100. The second input image is classified into the second class when input to the classification model 100.

The multiple sets of intermediate data include multiple sets of first intermediate data and multiple sets of second intermediate data. The multiple sets of first intermediate data are data output from the intermediate layer respectively when the multiple first input images are input to the classification model 100. The multiple sets of second intermediate data are data output from the intermediate layer respectively when the multiple second input images are input to the classification model 100.

Similarly, the multiple reference images that are the basis of the multiple sets of reference data include multiple first reference images and multiple second reference images. The first reference image is classified into the first class when input to the classification model 100. The second reference image is classified into the second class when input to the classification model 100.

The multiple sets of reference data include multiple sets of first reference data and multiple sets of second reference data. The multiple sets of first reference data are data output from the intermediate layer respectively when the multiple first reference images are input to the classification model 100. The multiple sets of second reference data are data output from the intermediate layer respectively when the multiple second reference images are input to the classification model 100.

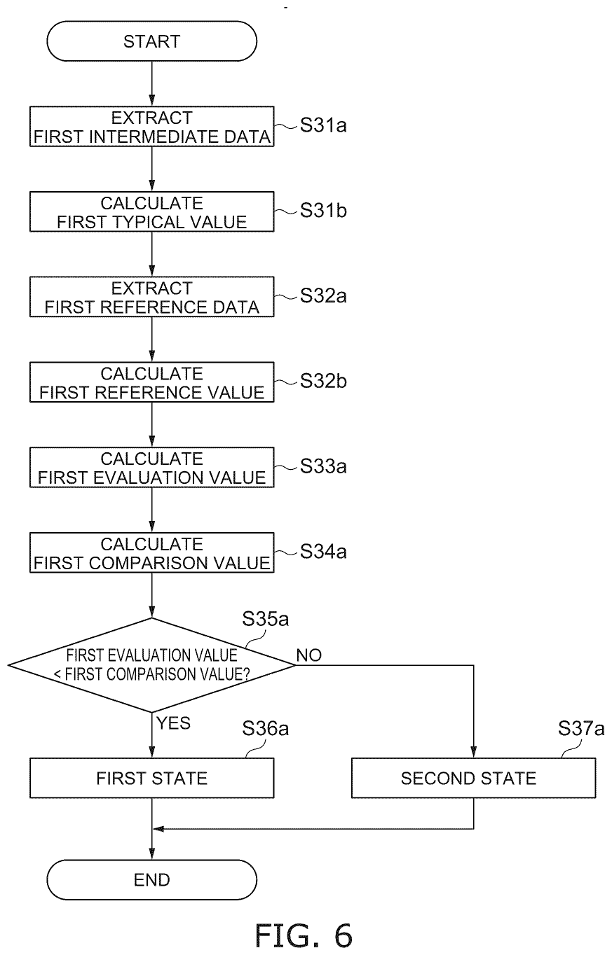

FIG. 6 is a flowchart showing a determination method of the suitability in a first modification.

The determination device 40 extracts multiple sets of first intermediate data from the multiple sets of intermediate data (step S31a). The determination device 40 calculates a first typical value by using the multiple sets of first intermediate data (step S31b). The first typical value is a median value or an average value of the multiple sets of first intermediate data. The first typical value may be a weighted average value or the like of the multiple sets of first intermediate data.

The determination device 40 extracts multiple sets of first reference data from the multiple sets of reference data (step S32a). The determination device 40 calculates a first reference value by using the multiple sets of first reference data (step S32b). The first reference value is a median value or an average value of the multiple sets of first reference data. The first reference value may be a weighted average value or the like of the multiple sets of first reference data. The first reference value is calculated by the same calculation method as that of the first typical value.

The determination device 40 calculates a first evaluation value by using the first typical value and the first reference value (step S33a). The first evaluation value is a distance or an angle between the first typical value and the first reference value. The determination device 40 calculates a first comparison value from the multiple sets of first reference data (step S34a). The first comparison value is set based on a distribution of the multiple sets of first reference data. For example, the first comparison value is calculated based on a standard deviation, mean squared error, variance, or quartiles (1Q and 3Q) of the multiple sets of first reference data.

The determination device 40 determines whether or not the first evaluation value is less than the first comparison value (step S35a). When the first evaluation value is less than the first comparison value, the determination device 40 determines that the suitability of the classification model 100 is in the first state (step S36a). When the first evaluation value is not less than the first comparison value, the determination device 40 determines that the suitability of the classification model 100 is in the second state (step S37a).

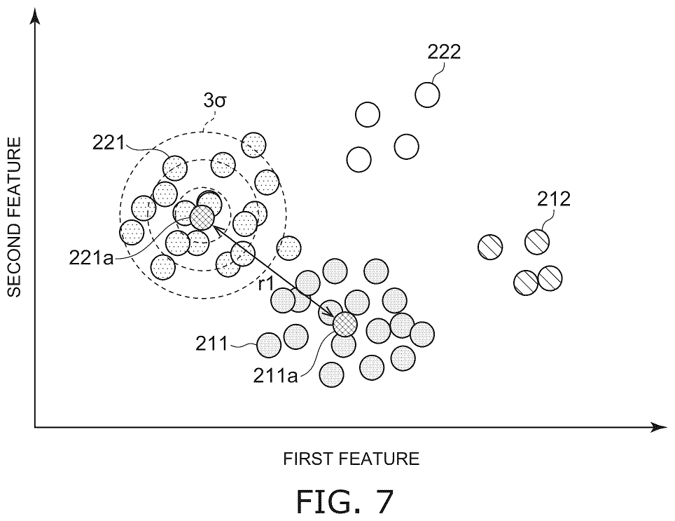

FIG. 7 is a schematic view for describing the determination method of the suitability according to the first modification. Similarly to FIG. 5, FIG. 7 shows the multiple sets of intermediate data 210 and the multiple sets of reference data 220. The multiple sets of intermediate data 210 include multiple sets of first intermediate data 211 and multiple sets of second intermediate data 212. The multiple sets of reference data 220 include multiple sets of first reference data 221 and multiple sets of second reference data 222.

The determination device 40 calculates a first typical value 211a of the multiple sets of first intermediate data 211 and a first reference value 221a of the multiple sets of first reference data 221. The determination device 40 calculates a distance r1 between the first typical value 211a and the first reference value 221a. The determination device 40 also calculates 3 times the standard deviation σ of the multiple sets of first reference data 221 as the first comparison value. The suitability of the classification model 100 is determined based on the comparison result between the distance r1 and the first comparison value 3σ.

When there is little bias in the data quantity between the multiple sets of first intermediate data and the multiple sets of second intermediate data, it is effective to use a method of determining the suitability by using the typical value, the reference value, etc., based on only images that are classified into some class. A change occurs more easily in a typical value that is based on only images classified into some class than in a typical value based on all of the intermediate data. For example, the degradation of the suitability is discovered more easily before the accuracy of the classification model decreases by determining the suitability using the first evaluation value based on only the multiple sets of first intermediate data, the first comparison value based on only the multiple sets of first reference data, etc.

For example, an inspection that uses the classification model 100 is applied to a production line. The article that is inspected is a part, a semifinished product partway through the manufacturing, a product after completion, etc. Typically, many of the articles inspected during manufacturing (particularly in mass production) are good parts. In other words, many of the input images are classified into a specific class (the first class). Therefore, the typical value, the reference value, the comparison value, etc., are greatly affected by the images classified into the specific class. In other words, the typical value based on all of the multiple sets of intermediate data can be considered to be substantially equal to the first typical value based on the multiple sets of first intermediate data. Similarly, the reference value based on all of the multiple sets of reference data can be considered to be substantially equal to the first reference value based on the multiple sets of first reference data.

The typical value, the reference value, etc., that correspond to the class are affected by the accuracy of the classification by the classification model 100. For example, when the accuracy of the classification model 100 decreases, the typical value, the reference value, etc., corresponding to the class also change. As a result, there is a possibility that the discovery of the degradation of the suitability may be delayed. When the ratio of the images classified into a specific class is large, the degradation of the suitability can be determined more stably regardless of the accuracy of the classification model 100 by calculating the typical value, the reference value, etc., by using all of the intermediate data and all of the reference data.

### Second Modification

In the example shown in FIGS. 6 and 7, the suitability of the classification model 100 is determined by using only the intermediate data and the reference data from images classified into one class. The suitability of the classification model 100 may be determined by further using the intermediate data and the reference data from images classified into another class. For example, the following processing (a second determination) is further performed in addition to the processing (a first determination) shown in the flowchart of FIG. 6.

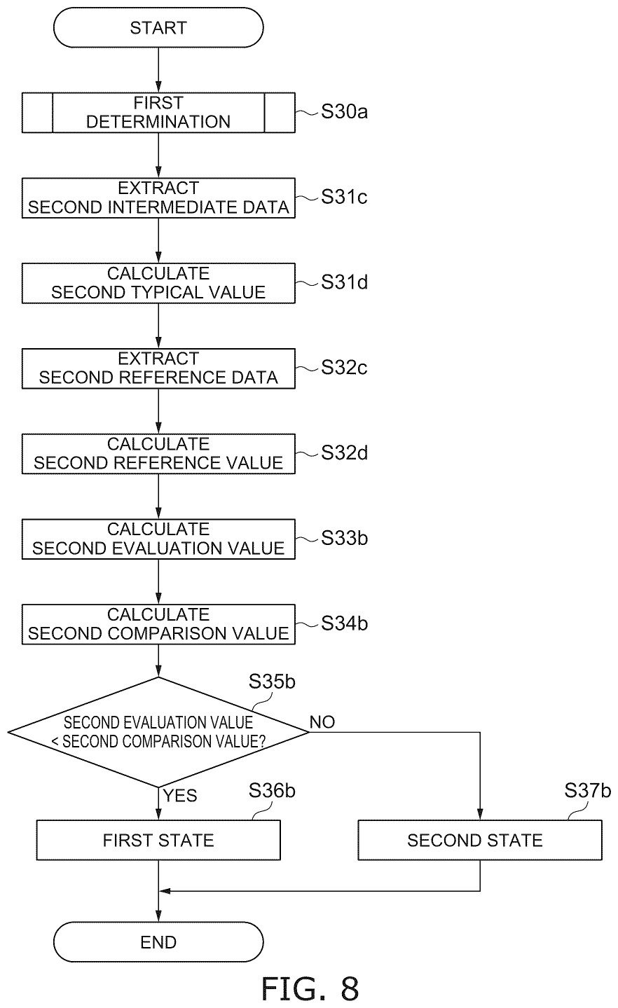

FIG. 8 is a flowchart showing a determination method of the suitability in a second modification.

First, the first determination shown in the flowchart of FIG. 6 is performed (step S30a). Then, the determination device 40 extracts multiple sets of second intermediate data from the multiple sets of intermediate data (step S31c). The determination device 40 calculates a second typical value by using the multiple sets of second intermediate data (step S31d). The second typical value is a median value or an average value of the multiple sets of second intermediate data. The second typical value may be a weighted average value or the like of the multiple sets of second intermediate data.

The determination device 40 extracts multiple sets of second reference data from the multiple sets of reference data (step S32c). The determination device 40 calculates a second reference value by using the multiple sets of second reference data (step S32d). The second reference value is a median value or an average value of the multiple sets of second reference data. The second reference value may be a weighted average value or the like of the multiple sets of second reference data.

The second typical value and the second reference value are calculated by the same calculation method as that of the first typical value and the first reference value.

The determination device 40 calculates a second evaluation value by using the second typical value and the second reference value (step S33b). The second evaluation value is a distance or an angle between the second typical value and the second reference value. The second evaluation value is calculated by the same calculation method as that of the first evaluation value.

The determination device 40 calculates a second comparison value from the multiple sets of second reference data (step S34b). The second comparison value is set based on a distribution of the multiple sets of second reference data. For example, the second comparison value is calculated based on a standard deviation, mean squared error, variance, or quartiles (1Q and 3Q) of the multiple sets of second reference data. The second comparison value is calculated by the same calculation method as that of the first comparison value.

The determination device 40 determines whether or not the second evaluation value is less than the second comparison value (step S35b). When the second evaluation value is less than the second comparison value, the determination device 40 determines that the suitability of the classification model 100 is in the first state (step S36b). When the second evaluation value is not less than the second comparison value, the determination device 40 determines that the suitability of the classification model 100 is in the second state (step S37b).

The determination device 40 outputs a final determination result of the suitability based on the determination results of the suitability of the classification model 100 of the first and second determinations. For example, the determination device 40 determines that the suitability of the classification model 100 is in the second state when the suitability is determined to be in the second state in at least one of the first determination or the second determination.

The degradation of the suitability of the classification model can be determined with higher accuracy by determining the suitability of the classification model 100 based on the images classified into each of multiple classes.

According to the modification described above, a value that indicates the distribution of the multiple sets of first intermediate data may be used as the first evaluation value; and the first comparison value may be set based on the distribution of the multiple sets of first reference data. For example, a standard deviation, mean squared error, variance, or quartiles (1Q and 3Q) of the multiple sets of first intermediate data are used as the first evaluation value. The first comparison value is set based on the standard deviation, mean squared error, variance, or quartiles (1Q and 3Q) of the multiple sets of first reference data.

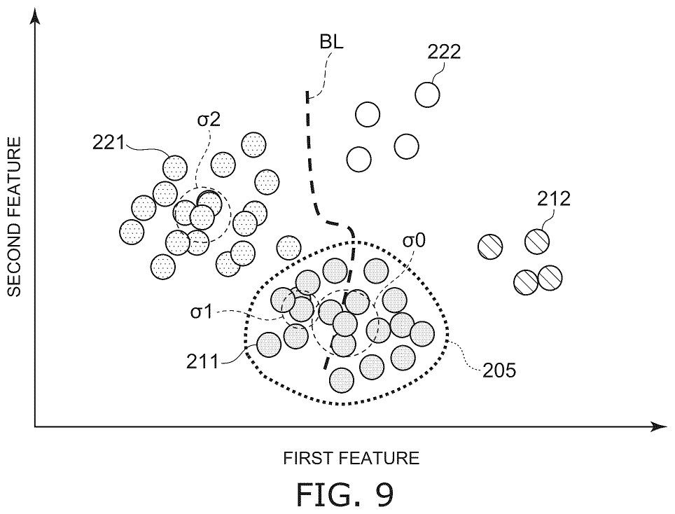

FIG. 9 is a schematic view for describing another determination method according to the first modification.

Similarly to FIG. 7, FIG. 9 shows the multiple sets of intermediate data 210 and the multiple sets of reference data 220. The multiple sets of intermediate data 210 include the multiple sets of first intermediate data 211 and the multiple sets of second intermediate data 212. The multiple sets of reference data 220 include the multiple sets of first reference data 221 and the multiple sets of second reference data 222. In FIG. 9, a boundary line BL illustrates the boundary between the classifications of a first class C1 and a second class C2.

When the quality of the input image changes, the intermediate data shifts compared to the reference data as shown in FIG. 9. As a result, images that should be classified into the first class may be classified into the second class. In FIG. 9, for example, an intermediate data set 205 includes multiple sets of intermediate data based on images that should be classified into the first class by the classification model 100. However, due to the change of the quality of the input image, the first intermediate data 211 based on the images classified into the first class and the second intermediate data 212 based on the images classified into the second class are mixed.

There are cases where the distribution of the intermediate data changes due to the shift of the intermediate data. As one specific example, the distribution of the intermediate data set 205 is represented by a standard deviation σ0. On the other hand, the distribution of the multiple sets of first intermediate data 211 is represented by a standard deviation σ1. The distribution of the multiple sets of first intermediate data 211 is smaller than the original distribution due to the intermediate data set 205 straddling the boundary line BL.

The determination device 40 sets the comparison value based on the distribution (a standard deviation σ2) of the multiple sets of first reference data 221. For example, 0.5 times the standard deviation 62 and 2 times the standard deviation σ2 each are set as comparison values. The determination device 40 calculates the standard deviation σ1 representing the distribution of the multiple sets of first intermediate data 211. The determination device 40 determines whether the standard deviation σ1 is greater than 0.5 times the standard deviation σ2 and less than 2 times the standard deviation σ2.

The standard deviation σ1 being within the range indicated by the comparison values indicates that the difference between the distribution of the multiple sets of first intermediate data 211 and the distribution of the multiple sets of first reference data 221 is small. In such a case, the determination device 40 determines that the suitability of the classification model 100 is in the first state. The standard deviation σ1 being outside the range indicated by the comparison values indicates that the distribution of the multiple sets of first intermediate data 211 has changed compared to the distribution of the multiple sets of first reference data 221. In such a case, the determination device 40 determines that the suitability of the classification model 100 is in the second state.

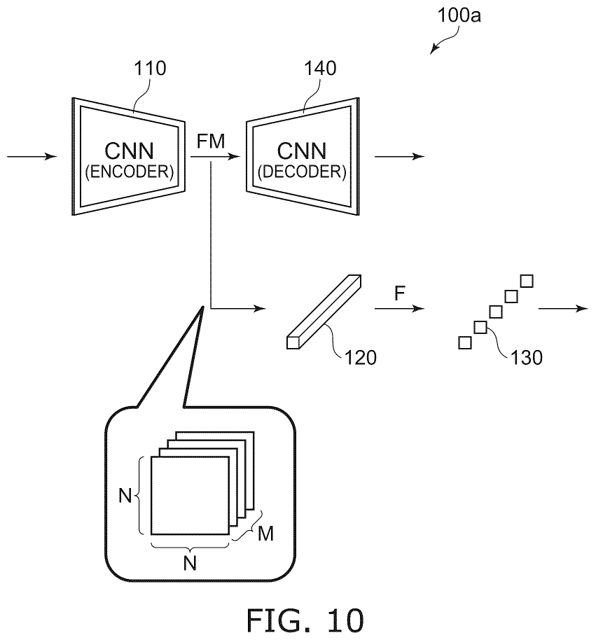

FIG. 10 is a schematic view showing another configuration of the classification model.

The determination method described above is applicable to a model other than the classification model 100 shown in FIG. 2 as long as a feature is obtained from the model. For example, the determination method according to the embodiment may be used for a classification model 100a shown in FIG. 10 instead of the classification model 100. Compared to the classification model 100, the classification model 100a further includes a generative model.

The feature map FM that is output from the CNN 110 is input to the fully connected layer 120 and the CNN 140. The function of the fully connected layer 120 in the classification model 100a is the same as the function of the fully connected layer 120 in the classification model 100.

The classification model 100a further includes the CNN 140 as a generative model. The CNN 140 restores the feature map FM to data of the same size as the input data, and outputs the data. In other words, the CNN 110 functions as an encoder; and the CNN 140 functions as a decoder.

The determination device 40 acquires the feature map FM output from the CNN 110 as the intermediate data. The determination device 40 performs the determination method described above by using the acquired intermediate data and the reference data prepared beforehand.

As an example, M feature maps FM having sizes of N×N are output from the CNN 110. The determination device 40 handles the feature of N×N×M dimensions corresponding to the M feature maps FM as the intermediate data, and uses the intermediate data to calculate the typical value, the evaluation value, etc. Similarly, the determination device 40 handles a feature of N×N×M dimensions as the reference data, and utilizes the reference data to calculate the reference value, the evaluation value, the comparison value, etc. Or, the determination device 40 may obtain a feature of M dimensions by calculating the typical value for each feature map FM. The determination device 40 handles the feature of M dimensions as the intermediate data.

As shown in FIG. 10, the data that is handled as the intermediate data is not limited to the output from the fully connected layer 120, and may be the output from the CNN 110. Also, the specific configuration of the model used as the classification model is not limited to the examples shown in FIGS. 2 and 10 and is modifiable as appropriate, as long as a feature is obtained from the model.

### Training

Multiple sets of training data are used to train the classification model described above. For example, the training data includes training images, and labels indicating the classes of the training images. The classification model is trained so that the classification model can output a classification result indicating a label when the training image is input.

The determination method according to the embodiment is particularly favorable for a classification model with metric learning. In metric learning, the classification model is trained so that, in the feature space of the intermediate layer, the distance is short between data based on images of the same class, and the distance is longer between data based on images of different classes.

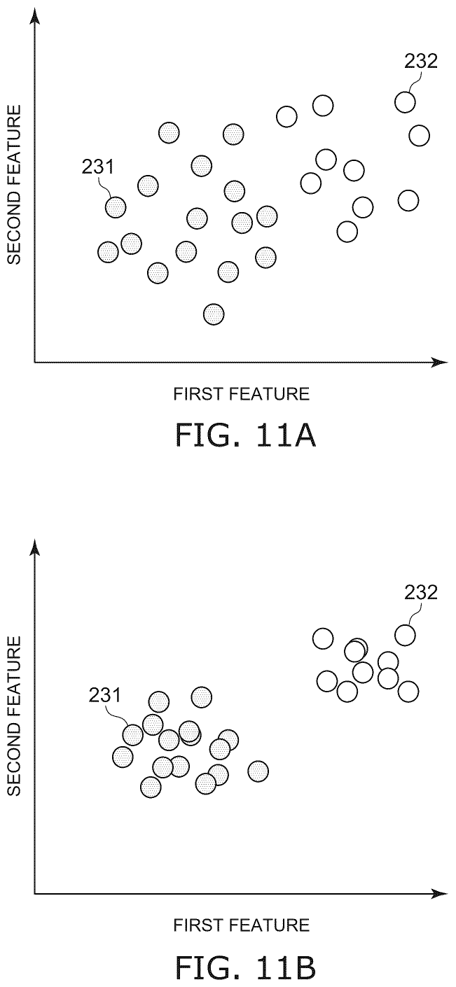

FIGS. 11A and 11B are schematic views showing effects of metric learning.

FIG. 11A shows first data 231 and second data 232. The first data 231 is the data of the intermediate layer when a first training image is input to the classification model. A first label that corresponds to the first class is assigned to the first training image. The second data 232 is the data of the intermediate layer when a second training image is input to the classification model. A second label that corresponds to the second class is assigned to the second training image.

As shown in FIG. 11B, metric learning results in a reduction of the distances within the first data 231. The distances within the second data 232 are reduced. Also, the distance between the first data 231 and the second data 232 is increased.

Specifically, triplet loss, contrastive loss, ArcFace, etc., can be used as the metric learning. As an example, triplet loss is used to train the classification model. In triplet loss, the training is performed using, as three images of one set, an anchor image as a reference, a positive image in the same class as the anchor, and a negative image in a different class from the anchor. In the feature space, an anchor-positive distance dp and an anchor-negative distance dn are calculated, and a loss function is defined to satisfy dp+α≤dn.

In mass production, there is a possibility that defective parts may have multiple defect modes. Therefore, when using triplet loss, it is considered inappropriate to reduce the distances within the data inside a class (a NG class) indicating defective parts. It is therefore favorable to use only the images classified into the class (the OK class) indicating good parts as the anchor image.

As described above, when metric learning is used, in particular, the distribution of the data of the intermediate layer is adjusted. According to the embodiment, the suitability is determined based on the trend of the data of the intermediate layer. In the classification model with metric learning, a change of the suitability easily appears as a change of the trend of the data of the intermediate layer. Therefore, according to the embodiment, the change of the suitability of the classification model with metric learning can be determined with higher accuracy.

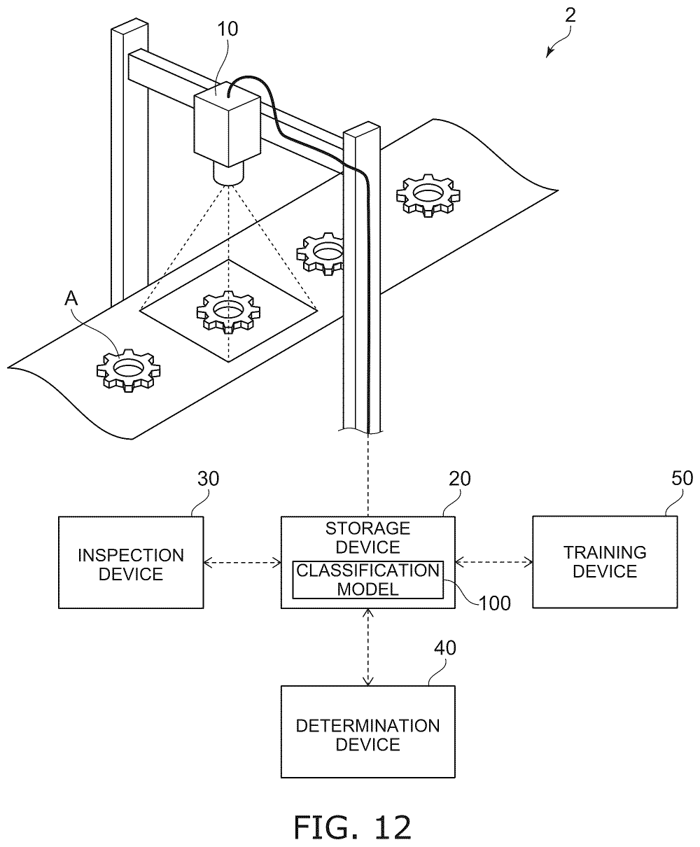

FIG. 12 is a schematic view showing a configuration of another inspection system according to an embodiment.

Compared with the inspection system 1 shown in FIG. 1, the inspection system 2 shown in FIG. 12 further includes a training device 50. The training device 50 trains the classification model 100 or 100a. The training device 50 stores the trained classification model 100 or 100a in the storage device 20.

As described above, training images, labels, etc., are used to train. It is favorable to perform metric learning. When the training by the training device 50 is completed, an inspection that uses the trained classification model 100 or 100a is started. After starting the inspection, the determination device 40 appropriately determines the suitability of the classification model 100 or 100a.

The determination device 40 described above also is applicable to a classification model used for something other than an inspection. As long as the classification model outputs a classification result according to the input of an image, the determination device 40 can determine the suitability of the classification model to the classification.

### Example

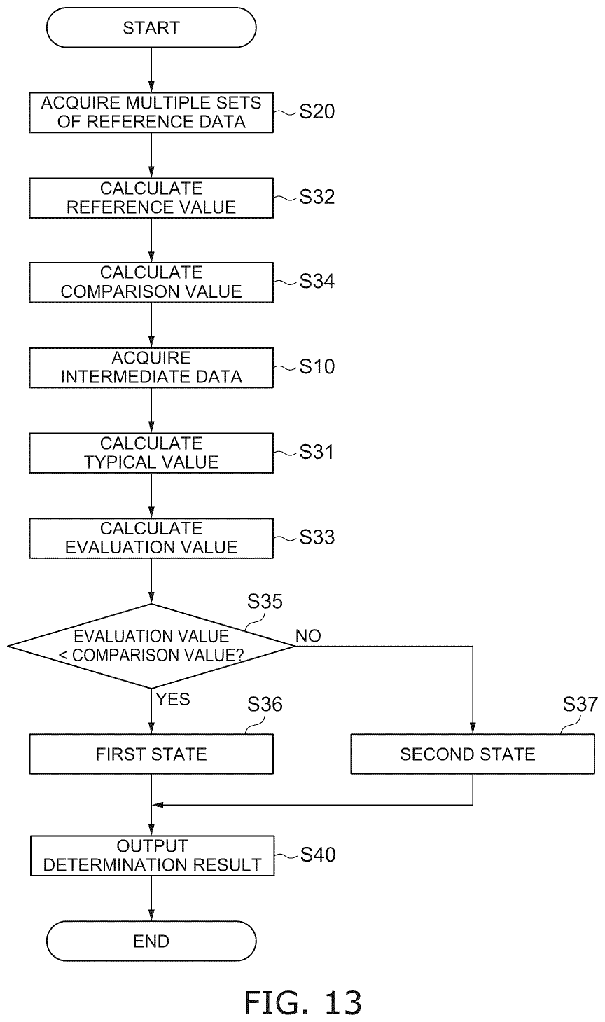

FIG. 13 is a flowchart showing an example of the determination method according to the embodiment.

In the example, the determination method according to the embodiment is repeatedly performed. As shown in FIG. 13, the determination device 40 acquires multiple sets of reference data that are prepared beforehand (step S20), and calculates a reference value and a comparison value (steps S32 and S34). Thereafter, the reference value and the comparison value that are initially calculated are repeatedly used. The determination device 40 determines the suitability of the model (steps S35 to S37) by calculating the typical value and the evaluation value (steps S31 and S33) each time the intermediate data is acquired (step S10). The determination device 40 outputs the determination result (step S40).

As an example, the inspection device 30 uses the classification model 100 to inspect one hundred articles per day. The determination device 40 uses, as reference data, intermediate data obtained over five days from the start of the inspection using the classification model 100. The determination device 40 uses the intermediate data obtained over the three days up to the newest intermediate data. The suitability of the classification model 100 is determined using the reference data and the intermediate data. The determination device 40 repeats the determination of the suitability every day.

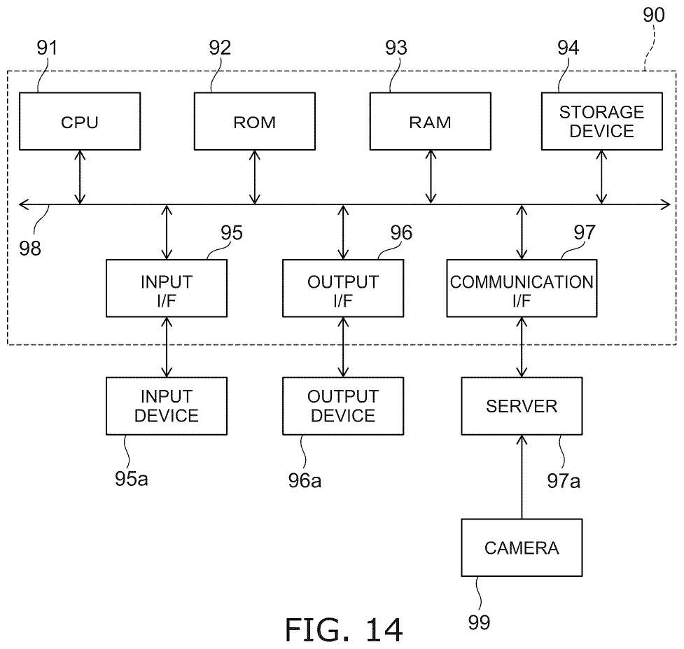

FIG. 14 is a schematic view showing a hardware configuration.

The inspection device 30, the determination device 40, and the training device 50 each include, for example, the hardware configuration shown in FIG. 14. A computer 90 shown in FIG. 14 includes a CPU 91, ROM 92, RAM 93, a storage device 94, an input interface 95, an output interface 96, and a communication interface 97.

The ROM 92 stores programs that control the operations of the computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs.

The input interface (I/F) 95 connects the computer 90 and an input device 95a. The input I/F 95 is, for example, a serial bus interface such as USB, etc. The CPU 91 can read various data from the input device 95a via the input I/F 95.

The output interface (I/F) 96 connects the computer 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and cause the output device 96a to display an image.

The communication interface (I/F) 97 connects the computer 90 and a server 97a outside the computer 90. The communication I/F 97 is, for example, a network card such as a LAN card, etc. The CPU 91 can read various data from the server 97a via the communication I/F 97. A camera 99 images the article and stores the image in the server 97a.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a speaker, and a printer. A device such as a touch panel that functions as both the input device 95a and the output device 96a may be used.

The storage device 94 may be used as the storage device 20. The camera 99 may be used as the imaging device 10.

The functions of the inspection device 30, the determination device 40, and the training device 50 each may be realized by one or two computers. For example, the inspection device 30 may include the functions of the determination device 40 and the training device 50. Or, the functions of the inspection device 30, the determination device 40, and the training device 50 may be realized by the collaboration of four or more computers.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

According to embodiments above, a determination device, an inspection system, and a determination method are provided in which the suitability of a classification model can be determined before the accuracy decreases. Similar effects can be obtained by causing a computer to perform the determination method described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A determination device,
the determination device being configured to determine a suitability of a classification model,
the classification model including a neural network,
the classification model being configured to output a classification result according to an input of an image,
the determination device being configured to:
acquire intermediate data of an intermediate layer of the neural network when an input image is input to the classification model; and
determine the suitability by using a plurality of sets of the intermediate data and a plurality of sets of reference data,
the plurality of sets of reference data being prepared beforehand.

2. The determination device according to claim 1, wherein
the classification model is trained by metric learning.

3. The determination device according to claim 1, wherein
the determination of the suitability includes:
calculating an evaluation value by using the plurality of sets of intermediate data; and
determining the suitability by comparing the evaluation value and a comparison value, and
the comparison value is set based on the plurality of sets of reference data.

4. The determination device according to claim 3, wherein
the determination device calculates the evaluation value to represent a similarity between the plurality of sets of intermediate data and the plurality of sets of reference data by using:
a typical value calculated using the plurality of sets of intermediate data; and
a reference value calculated using the plurality of sets of reference data.

5. The determination device according to claim 3, wherein
a plurality of the input images includes a plurality of first input images classified into a first class by the classification model,
the plurality of sets of intermediate data includes a plurality of sets of first intermediate data respectively based on inputs of the plurality of first input images to the classification model, and
the determination of the suitability includes calculating a first evaluation value as the evaluation value by using the plurality of sets of first intermediate data.

6. The determination device according to claim 5, wherein
the plurality of sets of reference data is acquired from the intermediate layer respectively when a plurality of reference images is input to the classification model,
the plurality of reference images includes a plurality of first reference images classified into the first class by the classification model,
the plurality of sets of reference data includes a plurality of sets of first reference data respectively based on inputs of the plurality of first reference images to the classification model, and
a first comparison value calculated using the plurality of sets of first reference data is set as the comparison value.

7. The determination device according to claim 6, wherein
the plurality of input images further includes a plurality of second input images classified into a second class by the classification model,
the plurality of sets of intermediate data further includes a plurality of sets of second intermediate data respectively based on inputs of the plurality of second input images to the classification model,
the plurality of reference images further includes a plurality of second reference images classified into the second class by the classification model,
the plurality of sets of reference data further includes a plurality of sets of second reference data respectively based on inputs of the plurality of second reference images to the classification model,
the determination of the suitability further includes:
calculating a second evaluation value by using the plurality of sets of second intermediate data; and
determining the suitability by comparing the second evaluation value and a second comparison value, and
the second comparison value is calculated using the plurality of sets of second reference data.

8. An inspection system, comprising:
the determination device according to claim 1;
an imaging device configured to acquire the input image by imaging an article; and
an inspection device configured to inspect the article visible in the input image by using the classification model.

9. A determination method, comprising:
determining a suitability of a classification model, the classification model including a neural network, the classification model being configured to output a classification result according to an input of an image;
acquiring intermediate data of an intermediate layer of the neural network when an input image is input to the classification model; and
determining the suitability by using a plurality of sets of the intermediate data and a plurality of sets of reference data,
the plurality of sets of reference data being prepared beforehand.

10. A storage medium configured to store a program,
the program, when executed by a computer, causing the computer to perform the determination method according to claim 9.
